(19) United States
(12) Patent Application Publication
(10) Pub. No.: US 2018/0106499 A1
(43) Pub. Date: Apr. 19, 2018

(54) HOT AND COOL FAN

(71) Applicant: HUNG HSING ELECTRIC CO., LTD., TAINAN CITY (TW)

(72) Inventors: PING HUANG, TAINAN CITY (TW); YING-PIN HUANG, TAINAN CITY (TW)

(21) Appl. No.: 15/297,462

(22) Filed: Oct. 19, 2016

(51) Int. Cl. F24H 3/02; F04D 25/08; F04D 29/28; F04D 29/42

(52) U.S. Cl. CPC F24H 3/022; F04D 25/08; H05B 2203/02; F04D 29/4226; F04D 29/281

(57) ABSTRACT

A hot and cool fan is revealed. An air distribution unit and a feed unit are mounted in a fan body. The feed unit consists of a driving part and a driven part connected to each other. An electric heating unit is connected to the driven part for being moved to be aligned with or away from an air exhaust part of the air distribution unit. Air from the air exhaust part is heated by the electric heating unit when the electric heating unit is aligned with the air exhaust part. Air is blown out of the air exhaust part smoothly when the electric heating unit is away from the air exhaust part of the air distribution unit. Thereby the fan is switched between a warm mode and a cold mode easily and there is a sufficient amount of wind available.

### BACKGROUND OF THE INVENTION

### Field of the Invention

The present invention relates to a hot and cool fan, especially to a hot and cool fan not only able to be switched between a warm mode and a cold mode easily but also to provide a sufficient amount of wind.

### Descriptions of Related Art

A hot and cool fan available now mainly includes a motor mounted in a main body and blades connected to a spindle of the motor. A plurality of rows of shield plates is arranged at an air outlet of the main body and each shield plate is disposed with an electric heating plate. The shield plates are turned to be at an open state and wind from the rotating blades is blown out through channels between the shield plates while in summer. In the winter time, the shield plates are turned to be in a half-open state. The wind from the rotating blades is passed through and heated by the electric heating plates on the shield plates to form warm air. However, the shield plates and electric heating plates on the air outlet cause loss in the amount and speed of the wind. Thus the cooling effect of the wind from the rotating fans is reduced and users are unable to be cooled off when the fan is used as a cool fan during the summer.

### SUMMARY OF THE INVENTION

Therefore it is a primary object of the present invention to provide a hot and cool fan that is not only easily switched between a warm mode and a cool mode but is also able to provide sufficient wind.

In order to achieve the above object, a hot and cool fan of the present invention includes a fan body with a mounting space formed therein, an air distribution unit, a feed unit and an electric heating unit. The air distribution unit and the feed unit are mounted in the mounting space. The feed unit consists of a driving part and a driven part connected to the driving part. The electric heating unit is set on the driven part for being moved to be corresponding to or away from an air exhaust part of the air distribution unit.

The fan body is disposed with at least one air inlet and at least one air outlet, both are communicating with the mounting space. The air exhaust part of the air distribution unit is corresponding to the air outlet of the fan body.

The fan body consists of a housing and a cover while the mounting space is formed inside the housing. One end of the housing is an opening end and at least one air inlet is disposed on surface of another end of the housing. The cover is arranged at the opening end of the housing and is set with at least one air outlet. Both the air inlet and the air outlet are communicating with the mounting space. The air exhaust part of the air distribution unit is corresponding to the air outlet of the fan body.

The driving part of the feed unit includes two rails set on two sides of the air exhaust part of the air distribution unit respectively and a rotating power source disposed on one side of one of the rails. The rotating power source is disposed with a spindle and a gear is connected to the spindle. The driven part is located between the two rails and each of two sides of the driven part is set with at least one roller. The roller on each side of the driven part is mounted and slidable in the rail respectively. A rack is disposed on one side of the driven part along the length direction thereof and is corresponding to the gear. The gear and the rack are engaged with each other.

The rotating power source of the feed unit can be a servo motor that turns back and forth.

The hot and cool fan further includes a stopping unit that is disposed in the mounting space of the housing and formed by a first stopper and a second stopper. The first stopper is set on one side of the driven part of the feed unit, toward the direction the driven part being moved. The second stopper is disposed on another side of the driven part, opposite to the side with the first stopper.

The hot and cool fan further includes a control unit arranged in the fan body. The control unit is coupled to the air distribution unit, the driving part of the feed unit, the electric heating unit, and the first stopper and the second stopper of the stopping unit.

Both the first stopper and the second stopper are microswitches.

The hot and cool fan further includes a control unit disposed in the fan body. The control unit is coupled to the air distribution unit, the driving part of the feed unit, and the electric heating unit.

The air distribution unit is a blower.

The electric heating unit is moveably aligned with or away from the air exhaust part of the air distribution unit by the design of the electric heating unit disposed on the driven part. Thereby the fan is easily shifted between a warm mode and a cold mode easily and there is a sufficient amount of wind available.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a front view of an embodiment according to the present invention;

FIG. 3 is a rear view of an embodiment according to the present invention;

FIG. 4 is a partial explosive view of an embodiment according to the present invention;

FIG. 5 is a schematic drawing showing an embodiment in a warm mode according to the present invention;

FIG. 6 is a schematic drawing showing an embodiment in a cool mode according to the present invention.

### DETAILED DESCRIPTION OF THE PREFERRED EMBODIMENT

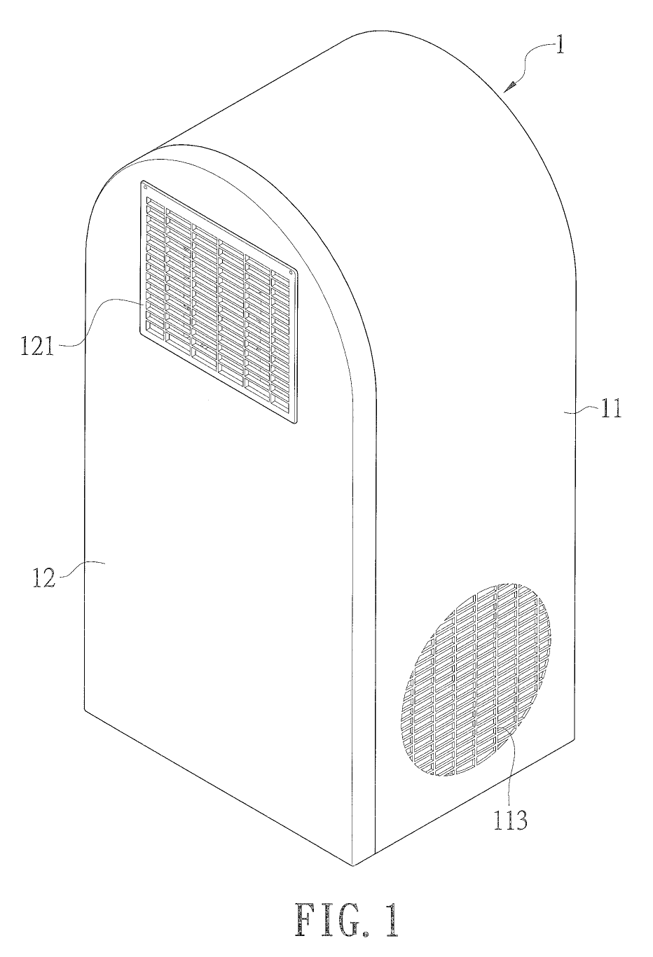

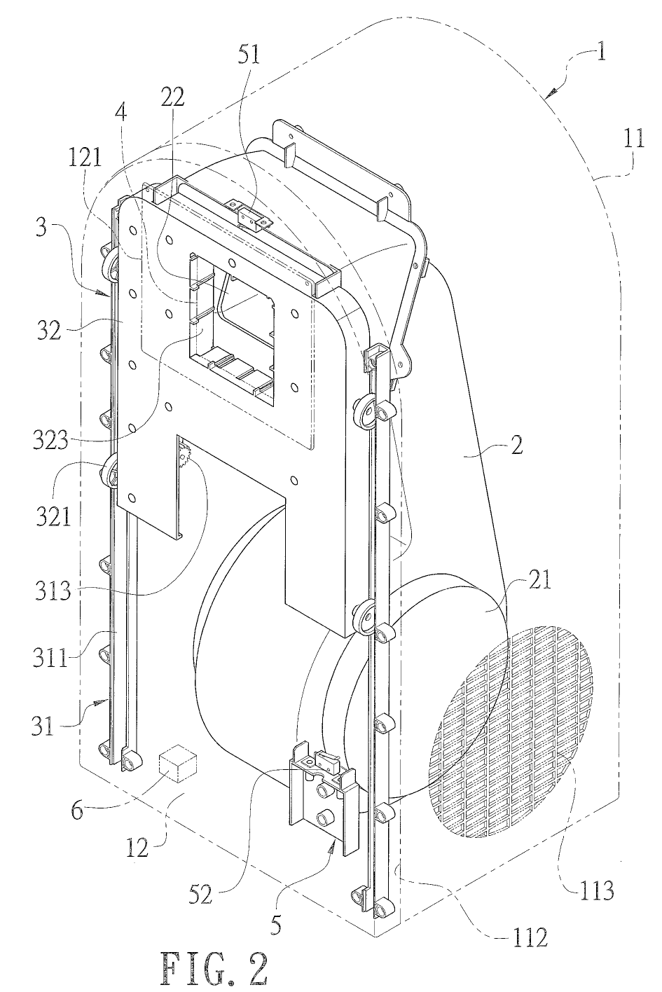

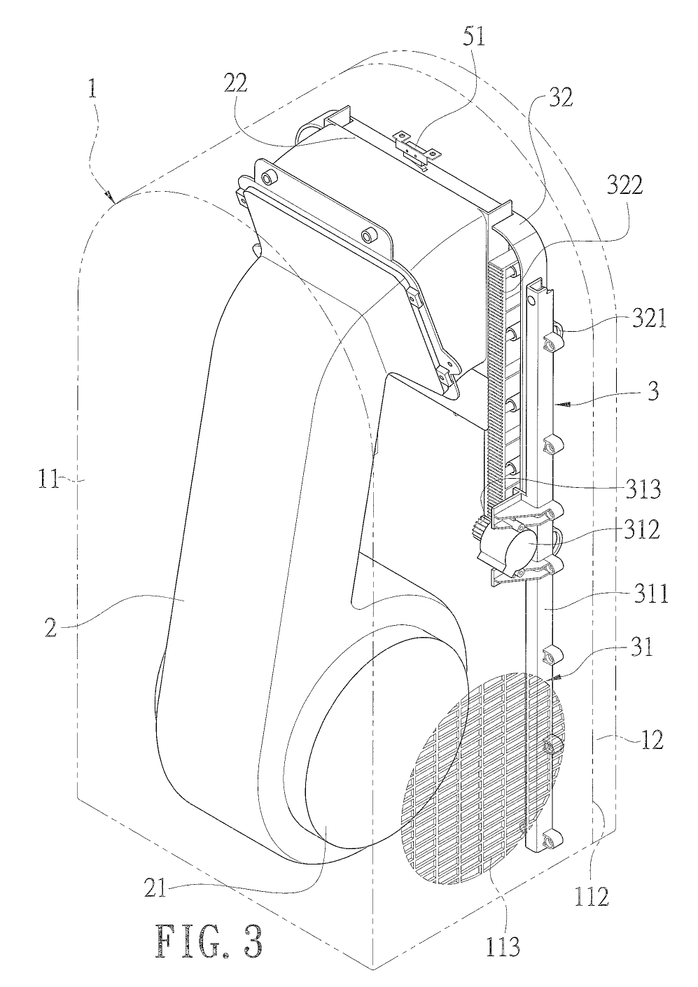

Refer to FIG. 1, FIG. 2 and FIG. 3, a hot and cool fan according to the present invention mainly includes a fan body 1, an air distribution unit 2, a feed unit 3, an electric heating unit 4, and a stopping unit 5.

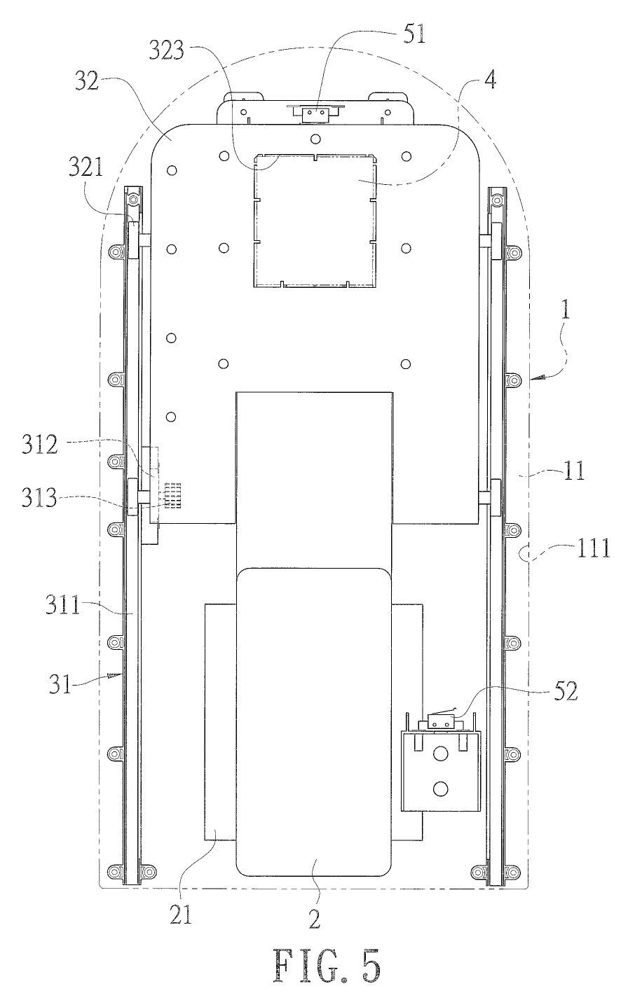

The fan body 1 consists of a housing 11 and a cover 12. A mounting space 111 is formed inside the housing 11, as shown in FIG. 5. An opening end 112 is formed on a front end of the housing 11 while at least one air inlet 113 is disposed on surface of another end of the housing 11 and is communicating with the mounting space 111. The air inlet 113 is in a grid design. The cover 12 is arranged at the opening end 112 of the housing 11 and is set with at least one air outlet. A grid-like plate 121 with a plurality of air vents is fastened on the air outlet of the cover 12.

The air distribution unit 2 can be a blower, being set in the mounting space 111 of the housing 11. An air intake part 21 of the air distribution unit 2 is corresponding to the air inlet 113 of the housing 11 while an air exhaust part 22 of the air distribution unit 2 is corresponding to the air outlet of the cover 12.

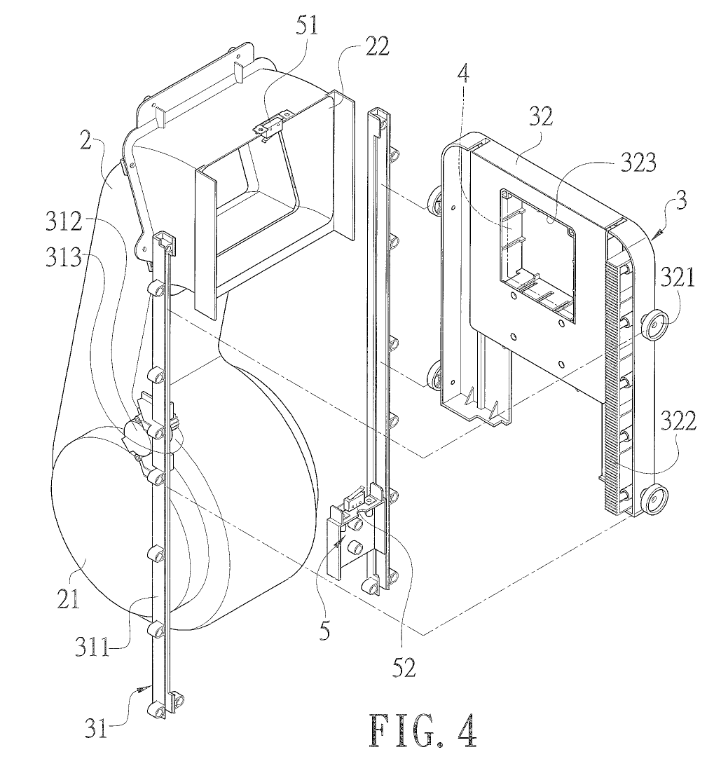

Also refer to FIG. 4, the feed unit 3 is disposed in the mounting space 111 of the housing 11. The feed unit 3 is composed of a driving part 31 and a driven part 32 connected to the driving part 31. The driving part 31 includes two rails 311 set on two sides of the air exhaust part 22 of the air distribution unit 2 respectively and a rotating power source 312 disposed on one side of one of the rails 311. The rotating power source 312 can be a servo motor that turns back and forth. A gear 313 is connected to a spindle of the rotating power source 312. The driven part 32 is located between the two rails 311 and each of two sides of the driven part 32 is arranged with at least one roller 321. The roller 321 on each side of the driven part 32 is mounted and slidable in the rail 311 respectively. A rack 322 is disposed on one side of the driven part 32 along the length direction thereof and is corresponding to the gear 313. The gear 313 and the rack 322 are engaged with each other. An assembly hole 323 is formed on one side of the driven part 32 that is corresponding to the air exhaust part 22 of the air distribution unit 2.

The electric heating unit 4 is mounted in the assembly hole 323 of the driven part 32 of the feed unit 3. The electric heating unit 4 can be formed by a plurality of ceramic positive temperature coefficient (PTC) thermistors.

Refer to FIG. 2, FIG. 4 and FIG. 5, the stopping unit 5 is disposed in the mounting space 111 of the housing 11 and having a first stopper 51 and a second stopper 52. The first stopper 51 is located on an upper side of the driven part 32 of the feed unit 3 and fastened on the air exhaust part 22 of the air distribution unit 2. The second stopper 52 is located on a lower side of the driven part 32 and fastened on one side of the rail 311. Both the first stopper 51 and the second stopper 52 are microswitches.

A control unit 6 is disposed in the housing 11 of the fan body 1 and having a first stopper 51 and a second stopper 52. The control unit 6 is coupled to the air distribution unit 2, the rotating power source 312 of the feed unit 3, the electric heating unit 4, and the first stopper 51 and the second stopper 52 of the stopping unit 5. The control unit 6 is further coupled to a fan-on button, a fan-off button, a heater-on button and a heater-off button on surface of the housing 11.

A power supply unit is set in the housing 11 of the fan body 1 and is coupled to the air distribution unit 2, the rotating power source 312 of the feed unit 3, the electric heating unit 4, the first stopper 51 and the second stopper 52 of the stopping unit 5, the fan-on button, the fan-off button, the heater-on button and the heater-off button through the control unit 6.

When the winder comes or the weather is cold, users can first press the fan-on button for driving the air distribution unit 2 to work. Then users press the heater-on button so as to make the control unit 6 drive the rotating power source 312 of the feed unit 3 to act. As shown in FIG. 5, the rotating power source 312 drives the gear 313 connected to the spindle thereof to rotate so that the rack 322 engaged with the gear 313 is also moved to allow the driven part 32 moving upward along with the rack 322. The driven part 32 is moved upward stably by the design of the rollers 321 on the two sides thereof sliding along the rails 311. When an upper edge of the driven part 32 is in contact with the first stopper 51 thereover, the first stopper 51 sends a signal to the control unit 6. Then the control unit 6 makes the rotating power source 312 stop working and drives the electric heating unit 4 to work. The electric heating unit 4 disposed on the driven part 32 is corresponding to the air exhaust part 22 of the air distribution unit 2. The wind from the air exhaust part 22 is passed through and heated by the electric heating unit 4 and then outputted from the air outlet of the cover 12 when the air distribution unit 2 delivers air from the air inlet 113 on the housing 11 of the fan body 1 to the air exhaust part 22 of the air distribution unit 2 through the air intake part 21 of the air distribution unit 2. Thereby the wind output is heated and users can feel warmer in the winder or cold weather.

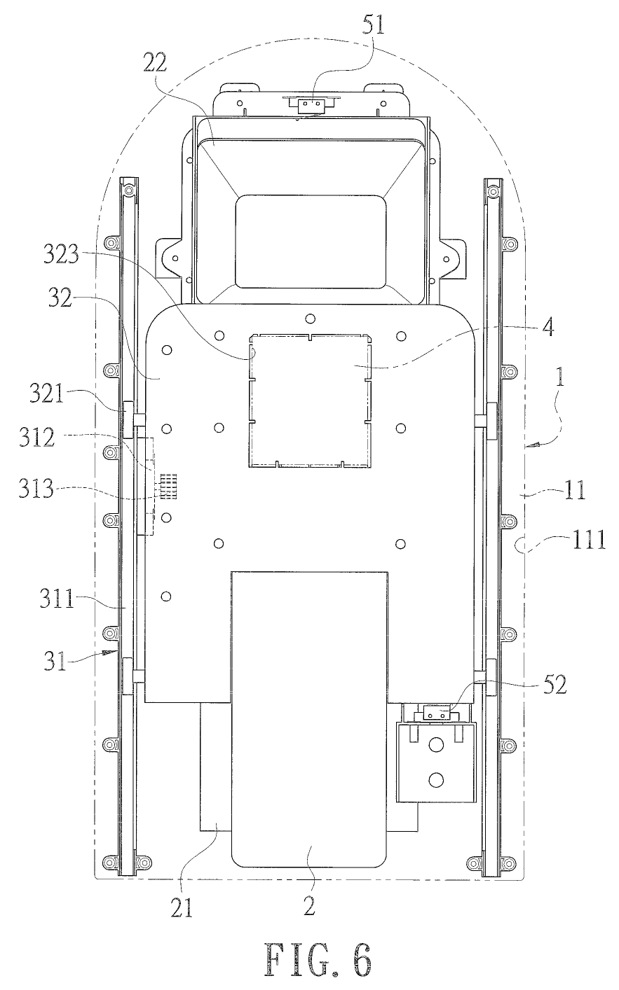

When it's summer or the weather is hot, users can first press the heater-off button so that the control unit 6 drives the electric heating unit 4 to stop working. Refer to FIG. 6, the rotating power source 312 acts in the opposite direction for driving the gear 313 connected thereto to rotate reversely. Thus the rack 322 engaged with the gear 313 and the driven part 32 with the rack 322 are moved downward. When a lower edge of the driven part 32 is in contact with the second stopper 52 thereunder, the second stopper 52 sends a signal to the control unit 6. Then the control unit 6 makes the rotating power source 312 stop working. At the moment, the driven part 32 and the electric heating unit 4 arranged thereon are moved away from the position corresponding to the air exhaust part 22 of the air distribution unit 2. Next users press the fan-on button so that the control unit 6 drives the air distribution unit 2 to work and air outside is delivered from the air inlet 113 on the housing 11 of the fan body 1 to the air exhaust part 22 of the air distribution unit 2 through the air intake part 21 of the air distribution unit 2. The wind formed will not be shielded because that both the driven part 32 and the electric heating unit 4 are away from the position corresponding to the air exhaust part 22 of the air distribution unit 2. The air is blown from the air exhaust part 22 of the air distribution unit 2 to the air outlet of the cover 12 of the fan body 1 directly and smoothly. By blowing sufficient air/wind around, the fan makes people feel cool and comfortable in summer or hot weather.

The fan-on button, the fan-off button, the heater-on button and the heater-off button of the present invention can be replaced by an on-and-off switch for the fan and an on-and-off switch for the heater. The arrangement of the buttons is simplified. The fan-on button, the fan-off button, the heater-on button and the heater-off button can also be disposed on other devices such as a transmitter of a remote controller. A receiver of the remote controller is arranged at the fan body 1 and coupled to the control unit 6. Thereby another operation mode is provided. Moreover, the design of the air inlet 113 on the housing 11 of the fan body 1 is not limited. Besides the grid design, the air inlet 113 can be designed to be many holes or a single hole. Or a plate with a plurality of air vents is fastened on the air inlet 113. Besides the plate with a plurality of air vents 121 fastened thereon, the air outlet of the cover 12 can also be designed to be a grid, many holes or a single hole. The rotating power source 312 is not only limited to be disposed on the rail 311. It can also be set on an inner wall of the fan body 1 and located on the rail 311. The driving part 31 of the feed unit 3 can be an electric cylinder, an air cylinder, etc. The first stopper 51 and the second stopper 52 are not restricted to be fastened on the air exhaust part 22 of the air distribution unit 2 and one side of the rail 311. The first and the second stoppers 51, 52 can be fastened on an inner wall of the fan body 1. The first stopper 51 and the second stopper 52 are not limited to be located on an upper side and a lower side of the driven part 32 of the feed unit 3. The positions of the first and the second stoppers 51, 52 can be modified as long as the first stopper 51 is on one side toward the moving direction of the driven part 32 of the feed unit 3 while the second stopper 52 is set on the opposite side.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A hot and cool fan comprising:
a fan body with a mounting space formed therein;
an air distribution unit arranged at the mounting space of the fan body;
a feed unit set in the mounting space of the fan body and having a driving part and a driven part connected to the driving part; and
an electric heating unit that is connected to the driven part for being moved to be corresponding to an air exhaust part of the air distribution unit or away from the air exhaust part of the air distribution unit.

2. The device as claimed in claim 1, wherein the fan body is disposed with at least one air inlet and at least one air outlet; the air inlet and the air outlet are communicating with the mounting space; the air exhaust part of the air distribution unit is corresponding to the air outlet of the fan body.

3. The device as claimed in claim 1, wherein the fan body includes a housing and a cover while the mounting space is formed inside the housing; an opening end is formed on one end of the housing and at least one air inlet is disposed on a surface of another end of the housing; the cover is arranged at the opening end of the housing and is set with at least one air outlet; both the air inlet and the air outlet are communicating with the mounting space; the air exhaust part of the air distribution unit is corresponding to the air outlet of the fan body.

4. The device as claimed in claim 1, wherein the driving part of the feed unit includes two rails set on two sides of the air exhaust part of the air distribution unit respectively and a rotating power source disposed on one side of one of the rails; the rotating power source is disposed with a spindle and a gear is connected to the spindle; the driven part is arranged between the two rails and each of two sides of the driven part is set with at least one roller; the rollers on the two sides of the driven part are mounted and slidable in the rails respectively; a rack is disposed on one side of the driven part along the length direction thereof and is corresponding to the gear; the gear and the rack are engaged with each other.

5. The device as claimed in claim 4, wherein the rotating power source of the feed unit is a servo motor that turns back and forth.

6. The device as claimed in claim 1, wherein the hot and cool fan further includes a stopping unit that is disposed in the mounting space of the fan body and having a first stopper and a second stopper; the first stopper is set on one side of the driven part of the feed unit, toward the direction the driven part being moved while the second stopper is located on another side of the driven part, opposite to the side with the first stopper.

7. The device as claimed in claim 6, wherein the hot and cool fan further includes a control unit that is arranged in the fan body and coupled to the air distribution unit, the driving part of the feed unit, the electric heating unit, and the first stopper and the second stopper of the stopping unit.

8. The device as claimed in claim 6, wherein both the first stopper and the second stopper are microswitches.

9. The device as claimed in claim 1, wherein the hot and cool fan further includes a control unit that is set in the fan body and coupled to the air distribution unit, the driving part of the feed unit, and the electric heating unit.

10. The device as claimed in claim 1, wherein the air distribution unit is a blower.
